(19) United States
(12) Patent Application Publication
(10) Pub. No.: US 2021/0103901 A1
(43) Pub. Date: Apr. 8, 2021

(54) SYSTEM AND METHOD OF FACILITATING TIPS OF VIRTUAL ITEMS OF VALUE

(71) Applicant: Bimodal LLC, Wilmington, DE (US)

(72) Inventor: Drake Sutton-Shearer, Los Angeles, CA (US)

(73) Assignee: Bimodal LLC, Wilmington, DE (US)

(21) Appl. No.: 16/901,978

(22) Filed: Jun. 15, 2020

Related U.S. Application Data
(63) Continuation of application No. 13/418,071, filed on Mar. 12, 2012, now abandoned.

(51) Int. Cl. G06Q 20/06; G06Q 50/10

(52) U.S. Cl. CPC G06Q 20/06; G06Q 50/10

(57) ABSTRACT

The payment of gratuities to service providers with virtual items of value may be enabled. This may enhance user engagement with a business, facilitate receiving meaningful feedback on service provider performance for a business, and/or may provide other enhancements. Users may be provided with an opportunity to earn and/or win virtual items of value that can, in turn, be used to pay gratuities to services providers associated with the business.

### CROSS-REFERENCE AND CLAIM OF PRIORITY

The present invention is a continuation of and claims benefit of priority to U.S. patent application Ser. No. 13/418,071, entitled SYSTEM AND METHOD OF FACILITATING TIPS OF VIRTUAL ITEMS OF VALUE, by Sutton-Shearer, filed 12-MAR.-2012, which is incorporated by reference herein in its entirety.

### FIELD

The disclosure relates to facilitating payment of gratuities to service providers in virtual items of value.

### BACKGROUND

Workers in service industries, or service providers, may rely on gratuities for some or all of the value they obtain for their services, to provide feedback for the level of service they provide, and/or for other purposes. Traditionally, gratuities have been provided in the form of real world funds.

### SUMMARY

One aspect of the disclosure relates to a system and method for facilitating payment of gratuities to service providers with virtual goods, virtual currency, and/or other virtual items of value. This may enhance customer engagement, improve the customer experience, facilitate distributions of value as gratuities to service providers, and/or provide other enhancements. The virtual items of value may include virtual items that have value solely in a virtual environment, and/or virtual items which can be exchanged for real world value.

The system may include one or more processors configured to execute computer program modules. The computer program modules may include one or more of a user account module, a service provider module, a gratuity designation module, a gratuity distribution module, a value acquisition module, a transaction module, and/or other modules.

The user account module may be configured to manage user accounts associated with users. The user account associated with a given user may include an indication of virtual items of value at the disposal of the given user in one or more virtual environments. These may include one or more of a virtual item of value under the control of the given user in one or more virtual environments, a virtual item previously distributed to the given user (e.g., by a merchant) for distribution as gratuities, a virtual item provided to the user by another user for distribution as a gratuity, a virtual item won or earned by the user while waiting for the service provider, and/or other virtual items of value.

The service provider module may be configured to receive service provider selections from users. A service provider selection may include an identification of a service provider to which a gratuity should be distributed. The service provider module may be configured to generate a graphical user interface for presentation to users through which users may enter and/or select service providers. The service provider module may be configured such that identification of a service provider in a service provider selection includes a service provider identifier provided to a user by the service provider. The service provider identifier may identify a service provider that includes a plurality of individuals. The service provider module may be configured such that responsive to reception of a service provider selection from the given user, the service provider module may provide, to the given user, identification of one or more virtual environments in which the identified service provider participates. This may enable the given user to give the service provider a virtual item of value that may have intrinsic value to the service provider.

The gratuity designation module may be configured to receive gratuity designations from users. A gratuity designation received from the given user may identify one or more virtual items of value to be distributed as a gratuity. The gratuity designation module may be configured to receive a purchase amount of a good or service provided by the service provider. Based on this information, the gratuity designation module may present to the given user virtual tip recommendations. A virtual tip recommendation may include a set of virtual items of value at the disposal of the given user within one or more virtual environments that would be provide a suitable gratuity for the service provider. The set of virtual items of value included in the virtual tip recommendation may be determined based on the purchase amount of the good or service provided by the service provider.

The gratuity distribution module may be configured to distribute gratuities of virtual items of value to service providers. The distribution may be in accordance with gratuity designations and/or service provider selections received via the gratuity designation module and/or the service provider module, respectively. For example, the gratuity distribution module may be configured such that responsive to reception of a service provider selection and a gratuity designation from the given user, the gratuity distribution module may distribute the one or more virtual items of value identified in the gratuity designation to the service provider identified in the service provider selection. The gratuity distribution module may be configured such that distribution of the designated one or more virtual items of value to the identified service provider includes effecting transfer of the designated one or more virtual items from the given user to the service provider in the one or more virtual environment in which the one or more virtual items exist.

Responsive to the given user designating a service provider that includes a plurality of individuals, the gratuity distribution module may divide the virtual items of value in the gratuity from the given user. This division may be in accordance with a predetermined distribution plan, based on the virtual environments the individuals participate in, based on a designation by one of the individuals or a supervisor of the individuals, and/or according to other schemes.

The value acquisition module may be configured to provide a virtual environment to the users. Through participation in one or more activities in the virtual environment the users may be awarded virtual items of value within the virtual environment. The one or more activities in the virtual environment for which the users may be awarded virtual items of value include one or more of a trivia game, a puzzle game, a shooter game, a strategy game, and/or other activities. The one or more activities in the virtual environment for which the users may be awarded virtual items of value may include one or more gaming activities in which the users put one or more virtual items of value at risk to gain the opportunity to win other virtual items of value. The value acquisition module may be configured to distribute virtual items of value to users in exchange for payment of real world funds. The value acquisition module may be configured to distribute virtual items of value to users as a reward for purchasing goods or services from the business. These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured to facilitate the payment of gratuities to service providers with virtual items of value.

FIG. 2 illustrates a user interface configured to receive a gratuity designation from a user.

FIG. 3 illustrates a method of facilitating payment of gratuities to service providers with virtual goods and/or virtual currency.

### DETAILED DESCRIPTION

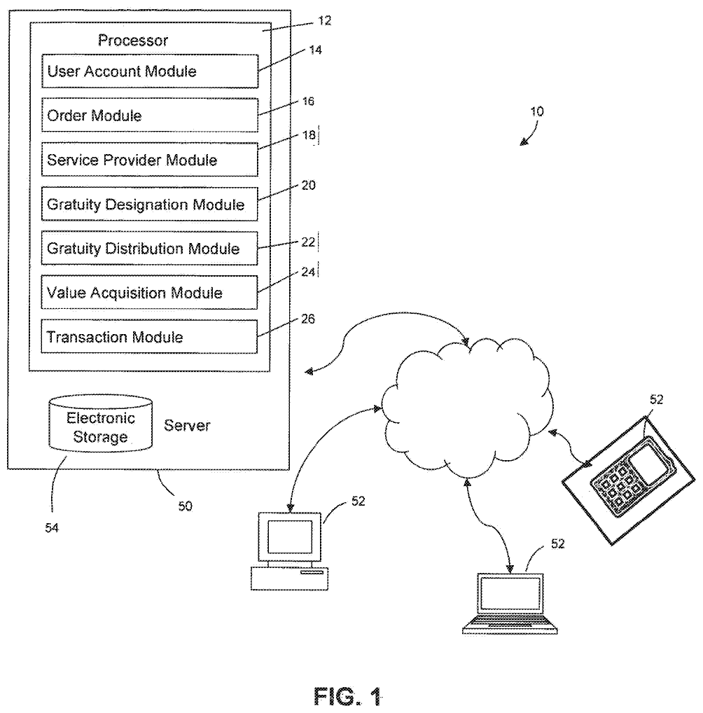

FIG. 1 illustrates a system 10 configured to facilitate the payment of gratuities to service providers with virtual items of value. The system 10 may be configured to enhance user engagement with a business implementing system 10, and/or may provide other enhancements. The system 10 may provide users with an opportunity to earn and/or win virtual items of value that can, in turn, be used to pay gratuities to services providers associated with the business.

As used herein, a “business” may refer to a provider of goods and/or services to consumers and/or other businesses. This may include a merchant having multiple locations, an individual merchant location, and/or other businesses. Some non-limiting examples of business types include a restaurant or food service business, a car wash, a grooming service provider (e.g., hair, nails, skin, and/or other grooming services), a massage parlor, and/or other businesses.

A virtual item of value may include a virtual good and/or a virtual currency. A virtual good may be a non-physical object that can be purchased, earned, won, or otherwise acquired for use, display, and/or possession in online communities, online games, virtual worlds, other virtual spaces, social networks, other interactive electronic social media, and/or other virtual environments. A virtual good may include, for example, such things as a digital gift, digital clothing for an avatar, virtual real estate, a digital badge, an avatar, augmented reality content, and/or any other virtual item. Sales of virtual goods may be referred to as microtransactions. Virtual goods may be distinguishable from other forms of digital media such as, for example, digital downloads of music, podcasts, films, television shows, pictures, and/or other digital media. For example, an instance of a virtual good may be perceived by a plurality of users within the virtual environment in which exists, but may be associated with (e.g., owned, controlled, or otherwise associated with) an individual user. As such, the instance of a virtual good may be passed between users, and a user may perceive the virtual good in the virtual environment without being able to receive some or all of the benefits of the virtual good. A virtual good may differ from other forms of digital media in that an the instance of a virtual good may exist in its virtual environment independent from whether one or more users are currently perceiving the instance of the virtual good.

A virtual currency may include electronic money. Virtual currency may not be contractually backed by tangible assets and/or may not be supported by legal tender laws of a sovereign nation or country. Virtual currency may not be, and/or may not represent a tangible commodity itself. Examples of virtual currencies include, without limitation, crypto-currencies, such as bitcoins, virtual funds used to purchase virtual goods within an online community, a social networking websites, a virtual worlds, an online gaming site, a website for buying and/or selling virtual goods, and/or other virtual environments.

As used herein, a “virtual environment” may include a virtual space, one or more interactive, electronic social media, and/or other virtual environments. A virtual game environment may refer to a virtual environment in which a game is being played that involves a plurality of users. Providing a virtual environment to users may include one or more of executing one or more instances of a virtual environment, determining view information representing the virtual environment (e.g., from the instance(s)) for the users (e.g., individually and/or collectively), transmitting the view information to computing platforms associated with the users to facilitate views of the virtual environment being presented to the users, presenting the views to the users, and/or other activities. A virtual space may comprise a simulated space that is accessible by users through views of the virtual space. The simulated space may have a simulated physical layout, express ongoing real-time interaction by one or more users, and/or be constrained by simulated physics that governs interactions between virtual objects in the simulated space. In some instances, the simulated physical layout may be a 2- dimensional layout. In other instances, the simulated physical layout may be a 3- dimensional layout.

The above description of virtual spaces is not intended to be limiting. The virtual space may be expressed in a more limited, or more rich, manner. For example, views of the virtual space presented to the users may be selected from a limited set of graphics depicting an event in a given place within the virtual space. The views may include additional content (e.g., text, audio, pre-stored video content, movable icons, avatars, and/or other content) that describes particulars of the current state of the space, beyond the relatively generic graphics. For example, a view of the virtual space may depict a card table and/or a non-player character that are static (or change relatively little) visually in views of virtual space. Icons representing game components (e.g., game pieces, playing cards, dice, and/or other game components) may change and/or move within the views of the virtual space to depict a game being played within the virtual space. Other expressions of individual places within the virtual space are contemplated.

Within the instance(s) of the virtual space (or other virtual environment), users may control avatars to interact with the virtual space and/or each other. As used herein, the term “user character” may refer to an object (or group of objects) present in the virtual space that represents an individual user. The avatar may be controlled by the user with which it is associated. The avatars may move through and interact with the virtual space (e.g., non-user characters in the virtual space, other objects in the virtual space), or the avatars may be relatively static visually within views of virtual space. The avatar representing a given user may be created and/or customized by the given user. The user may have an “inventory” of virtual goods and/or currency that the user can use (e.g., by manipulation of an avatar or other user controlled element, and/or other items), display, gift, and/or otherwise interact with within the virtual space. This inventor may include virtual items of value earned or purchased by another user that is placed under control of the user (e.g., communally, or from one user to a specified other user).

The users may participate in the virtual space by controlling one or more of the available user controlled elements in the virtual space (e.g., game elements, avatars, and/or other elements). Control may be exercised through control inputs and/or commands input by the users.

Interactive, electronic social media may include one or more of a social network, a virtual space, a micro-blogging service, a blog service (or host), a browser-based game, a multi-player mobile game, a file (e.g., image file, video file, and/or other files) sharing service, a messaging service, a message board, a forum, and/or other electronically distributed media that are scalable and enable interaction between the users. As was the case with virtual spaces, in some implementations, users may be represented within interactive, electronic social media by avatars. An avatar representing a given user may be presented in views of the interactive, electronic social media as being associated with content that may be provided by the given user, directed the given user, related to the given user, and/or associated with the given user in other ways. Some non-limiting specific examples of interactive, electronic social media may include the micro-blogging service provided by Twitter™, the social network provided by Facebook™, the social network provided by MySpace™, the social network provided by Foursquare®, the virtual world provided by Secondlife®, the massively multi-player online game provided by World of Warcraft®, the file sharing service provided by Flickr®, Blogger, YouTube, PlayStation® Home, Xbox® Live, and/or other interactive electronic social media.

The system 10 may include one or more processors 12 configured to execute one or more computer program modules. The one or more computer program modules may include one or more of a user account module 14, an order module 16, a service provider module 18, a gratuity designation module 20, a gratuity distribution module 22, a value acquisition module 24, a transaction module 26, and/or other modules.

The user account module 14 may be configured to access and/or manage one or more user accounts associated with users of the system 10. The user accounts may include, for example, friend information (e.g., information related to friends of a user), virtual environment usage information, demographic information associated with users, interaction history among users in one or more virtual environments and/or other environments, information stated by users, purchase information of users, browsing history of users, inventory information (e.g., virtual objects owned and/or controlled by the users), virtual currency information, and/or other information related to users. As such, the user account associated with a given user may include an indication of virtual items of value at the disposal of the given user. The user account associated with the given user may include a history of purchases and/or gratuities made by the given user in the past. The history of purchases and/or gratuities may include purchases and/or gratuities made by the given user using real world funds, virtual currency, and/or other funds.

The user account of the given user may include account information for the given user in one or more virtual environments. The one or more virtual environments may include one or more virtual environments hosted by system 10, and/or one or more external virtual environments. The account information in a given virtual environment may include one or more of a user name, a password or login, an avatar definition, inventory information, virtual currency information, friend information, and/or other information. Account information for a virtual environment (e.g., an external virtual environment) may be obtained by user account module 14 via one or more application programming interfaces provided by the virtual environment server.

The user account of the given user may include one or more virtual item pools of users the given user belongs to. A virtual item pool may include a pool of virtual items available to any of the users that belong to the virtual item pool for distribution as a gratuity. The virtual item pool may require its member users to regularly contribute virtual items, and/or monetary value with which virtual items can be purchased, to the virtual item pool to replenish the virtual item pool. The virtual item pool may accept voluntary contributions from its members and/or other users to replenish the virtual item pool. The virtual item pool may be replenished from other sources.

The user account module 14 may be configured to manage user accounts for one or more users that will be giving a gratuity and/or one or more users that will be receiving a gratuity. For convenience, a user that will be giving a gratuity may be referred to as a user. A user that will be receiving a gratuity may be referred to herein as a service provider.

The order module 16 may be configured to receive user orders for the goods and/or services provided by a business implementing system 10. The order module 16 may be configured to generate a user interface through which the user inputs an order. The order module 16 may be configured to generate a user interface through which a service provider inputs an order on behalf of a user. Inputting the order may include indicating which goods and/or services the user will be purchasing from the business, the quantity of goods and/or services, the delivery mechanism for one or more of the goods and/or services, a schedule for delivery and/or performance of the goods and/or services, and/or other parameters for a purchase of the goods and/or services.

The order module 16 may be configured to receive payment information from users. The payment information may effect payment by a user to the business for the goods and/or services being purchased. Payment information may include one or more of payment account information, purchase confirmation, security information, and/or other information. Purchase account information may designate an account of the user from which payment should be made to the business. Such an account may include, for example, a credit account, a bank account, a pay anyone account, a virtual currency account, and/or other accounts.

The service provider module 18 may be configured to receive service provider selections from users. A service provider selection may include an identification of a service provider to which a gratuity should be distributed. The identification of the service provider may be received via manual entry by the user, may be received automatically, may be received via selection by the user from a set of possible options, and/or may be received in other ways.

Manual entry of the identification may include a name of the service provider, a location of the service provider, an alphanumeric identifier associated with the service provider, and/or other mechanisms for identifying service providers. Manual entry of an identification of a service provider may be received through a user interface field presented to the user. In some implementations, the identification of the service provider may be presented to the user via a badge, a sign, a placard and/or other visual indications presented to the user (e.g., at the business). The identification of the service provider may be presented to the user for manual entry verbally by the service provider.

Automatic identification of the service provider may be accomplished via a machine readable marker associated with the service provider and/or the business. For example, a sign, a wearable badge, a placard, and/or other structure or display may bear one or more of a near-field communication marker, an RF transponder, an optical code (e.g., a barcode, a Quick Read code, and/or other optical codes), and/or other machine readable markers. A client computing platform associated with the user may be implemented to read the marker, and to provide the identification information read from the marker to service provider module 18. If the client computing platform is provided by the business, the client computing platform may be associated (e.g., installed at, carried with, and/or associated in other ways) with a specific service provider and/or station (e.g., table, chair, parking stall, and/or other stations) at a business) at the business. Automatic identification of the service provider in such implementations may be at least partially performed by recognizing the client computing platform. Other techniques for automatically identifying a service provider are contemplated.

The service provider module 18 may be configured to obtain one or more criteria related to the surroundings of the user, and may present a set of options to the user through which the user can select the appropriate service provider. Such criteria may include, for example, a location, a specific station, a time of day, a date or day of the week, and/or other criteria. Based on this criteria, service provider module 18 may determine a set of service providers likely to be facilitating the purchase of the user from the business. The set may be determined by referencing a worker roster, a worker schedule, and/or other information. The criteria may be obtained by service provider module 18 through manual entry and/or selection by the user, through automated detection (e.g., GPS, time/date programs, and/or other automated detection), and/or via other mechanisms for obtaining such criteria.

In some implementations, a service provider may refer to a plurality of individuals working on behalf of the business. For example, at a restaurant, the service provider for a given user may include a host or hostess, a waiter or waitress, a bartender, one or more servers, one or more busboys, and/or other staff at the restaurant. As another example, at a salon, the service provider may include a stylist, a shampooer, and/or other staff at the salon. It will be apparent that in such implementations, a given worker may be included in a plurality of different service provider groups. For example, a hostess at the restaurant may seat guests to be served by a plurality of different waitresses. The service provider group for each waitress may include the same hostess. As such, the hostess may receive a portion of gratuities distributed to each of the servicer provider groups in which the hostess is included. As another example, a shampooer may service clients of a plurality of hair stylists and, as such, may receive a portion of the gratuities distributed to service provide groups associated with individual ones of the hair stylists. Other examples of individual service providers belonging to a plurality of service provider groups may exist.

The gratuity designation module 20 may be configured to receive gratuity designations from the users. A gratuity designation may identify one or more virtual items of value to be distributed as a gratuity (e.g., to a service provider selected through service provider module 18). The gratuity module 20 may be configured to receive gratuity designation from the users via a user interface that is presented to the users. The user interface may be presented to users on a platform associated with a business (e.g., a point-of-sale device, a client device located at a user station, and/or through other platforms associated with a business), on client computing platforms associated with the users, and/or other platforms.

The user interface may include fields through which the users select and/or enter information about a gratuity (e.g., a service provider and/or service provider group, virtual items to be included, and/or other information). The information selected and/or entered to the fields may be transmitted to gratuity designation module 20. The fields may include one or more fields that are at least partially populated automatically (e.g., several different options for a given field may be automatically populated and provided for selection to a user). The information used to populate the fields and/or selectable options for the fields may be obtained, for example, from one or more of the other modules 14, 16, and/or 18, may be obtained from one or more external sources (e.g., from a virtual environment operator), and/or may be obtained from other sources.

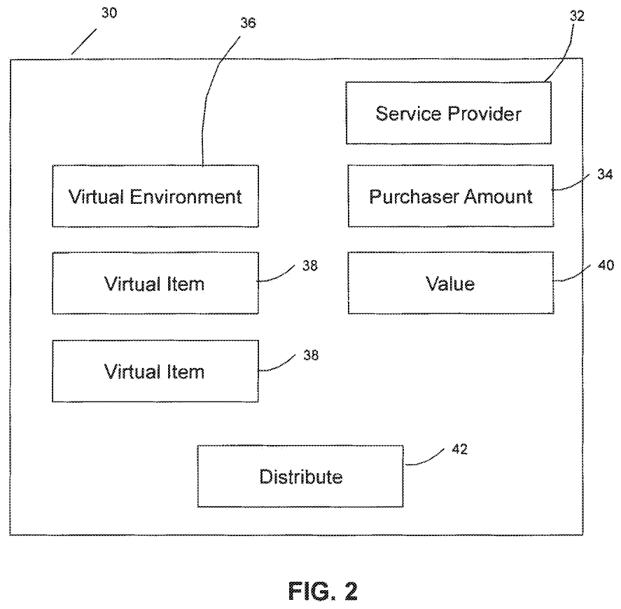

By way of illustration, FIG. 2 illustrates a user interface 30 configured to receive a gratuity designation from a user. The user interface 30 may include one or more of a service provider field 32, a purchase amount field 34, a virtual environment field 36, a virtual item field 38, a value field 40, and/or other fields. User interface 30 may be generated and/or populated (in part or in total) by a gratuity designation module similar to or the same as gratuity designation module 20 (shown in FIG. 1 and described herein). User interface 30 may be presented to the user on a client computing platform similar to or the same as client computing platforms 52 (shown in FIG. 1 and described herein).

The service provider field 32 may be configured to present to the user the service provider for which the gratuity is being designated. The service provider field 32 may be populated based on a previous identification of the service provider (e.g., by a service provider module similar to or the same as service provider module 18 shown in FIG. 1).

The purchase amount field 34 may indicate a purchase amount of the good or service being purchased from the business. The purchase amount may be selected and/or entered by the user via purchase amount field 34, or the purchase amount may be received and purchase amount field 34 may be populated automatically.

The virtual environment field 36 may present one or more virtual environments in which the service provider participates. The one or more virtual environments in which the service provider participates may be determined based on a user account associated with the service provider (e.g., managed by a user account module similar to or the same as user account module 14 shown in FIG. 1). The one or more virtual environments presented in virtual environment field 36 may include virtual environments in which both the service provider and the user participate. This may facilitate gratuities of virtual items of value within these virtual environments. In implementations in which the service provider includes a plurality of individuals, the one or more virtual environments may include virtual environments in which at least one of the individuals participates, virtual environments in which all of the individuals participate, and/or virtual environments.

In some implementations, rather than simply presenting one or more virtual environments in which the service provider participates, virtual environment field 36 may be configured to receive entry and/or selection of the virtual environment(s) by the user. This may include receive manual entry of the virtual environment(s) and/or selection of the virtual environment(s) from a set of potential virtual environments. The set of virtual environments may be determined based on one or both of the virtual environments in which the user participates and/or the virtual environments in which the service provider participates.

The virtual item field 38 may be configured to receive entry and/or selection of one or more virtual items of value to be included in a gratuity for the service provider. The virtual item(s) of value may be entered manually by the user, and/or may be selected from a set of potential virtual items of value. The set of potential virtual items of value may be determined based on virtual items of value owned or controlled by the user in the virtual environment(s) designated in virtual environment field 36, the purchase amount, virtual items of value owned or controlled by the service provider in the virtual environment(s), and/or other parameters. The set of potential virtual items of value may, in some implementations may reflect designations of desired virtual items of value previously made by the service provider (e.g., virtual items of value the service provider is trying to acquire).

The value field 40 may be configured to present a nominal value of the virtual items of value to the user. The value may be denominated in a real world currency. This may give the user an idea of the value of the gratuity that will be distributed to the service provider. The value may be determined based on one or more of cost of the virtual items of value in real world currency from a virtual environment provider, an average cost of the virtual items of value in real world currency in an environment auction house, and/or determined based on other criteria.

In some implementations, value field 40 may be configured to receive entry and/or selection by the user of a real world value for the gratuity. Based on this entry and/or selection, one or more virtual items of value may be presented to the user in virtual item field 38 for review by the user. This may enable the user to quickly identify an appropriate gratuity of virtual items of value having the real world value commiserate with the level of service provided to the user by the service provider.

The user interface 30 may include a distribution initiation field 42. The distribution initiation field 42 may be configured to be selected by the user to initiate distribution of the virtual items of value designated in virtual item field 38 to the service provider.

Referring back to FIG. 1, service provider module 18 and/or gratuity designation module 20 may be configured to facilitate gratuities to be given by users some time after a transaction. By way of non-limiting example, a user may access service provider module 18 and/or gratuity designation module 20 some time after a purchase (e.g., through a website, a mobile application, an email, a text message, and/or other electronic communication) and designate a receipt or transaction number, and a gratuity that should be distributed. The service provider may be identified based on the receipt or transaction number, and/or may be identified manually by the user.

The gratuity distribution module 22 may be configured to distribute gratuities of virtual items of value to service providers. The gratuity distribution module 22 may be configured such that responsive to reception of a service provider selection via service provider module 18 and a gratuity designation via gratuity designation module 20 from a given user, gratuity distribution module 22 distributes the one or more virtual items of value identified in the gratuity designation to the identified service provider. This may include communicating with the appropriate virtual environments to indicate that the virtual item(s) of value should be removed from the ownership and/or control of the given user and/or delivered to the ownership and/or control of the identified service provider. This may effect transfer of the designated one or more virtual items of value from the given user to the service provider in the one or more virtual environments in which the one or more virtual items of value exist.

As was mentioned above, in some implementations, the service provider may include a plurality of individuals providing service to the user. In such implementations, gratuity distribution module 22 may be configured to divide the virtual items of value in a gratuity between the individuals included in the service provider. This division may be made based on preferences and/or settings previously configured by the individuals, based on specific selections by the users (e.g., through a lottery and/or in a turn-based manner), based on user inputs from a user provider tasked with dividing the virtual items of value (e.g., a waiter may manually select the division to be paid out to a hostess, busboys, a bartender, and/or other fellow service providers), and/or through other mechanisms for dividing the virtual items of value. The division of the virtual items of value between the individuals may be consistent with pre-configured percentages (e.g., bartender receives some percentage of the gratuities received by the waitresses). The division may be made on a per-gratuity basis, or virtual items of value for a service provider may be held en masse until an ultimate division and distribution is made. For example, after a shift is over, the virtual items of value given collectively to a service provider may be divided among the individuals in the service provider.

Gratuity distribution module 22 may be configured to track the distributions of virtual items as gratuities. This may include, for example, tracking the transfer of ownership from the user to the service provider, subsequent use by the service provider, subsequent transfer from the service provider to someone else, redemption (e.g., for real world money) by the service provider, and/or other activities taken with respect to the virtual items distributed in gratuities. Such information may be implemented by the retailer to monitor service provider performance, by the retailer to track customer satisfaction with service, by an operator of system 10 to track use and/or user experience, and/or for other purposes.

The value acquisition module 24 may be configured to facilitate acquisition by the users of virtual items of value in one or more virtual environments. The virtual items of value acquired may be available in one or more virtual environments hosted by system 10 and/or one or more virtual environments that are external to system 10. The virtual items of value may be bought, won, traded, received, and/or otherwise acquired by users via value acquisition module 24. The virtual items of value acquired by users through value acquisition module 24 may be distributed to service providers in gratuities (e.g., as described herein using system 10).

In some implementations, value acquisition module 24 may be configured to provide a virtual environment to users. Through participation in one or more activities in the virtual environment the users may be awarded virtual items of value within the virtual environment. These activities may give the users something to do while waiting for and/or receiving the goods and/or services being provided by the business. For example, in a restaurant, while users are waiting for a table and/or waiting for food or drinks at the table, the users may participate in the activities within the virtual environment. Virtual items of value acquired during such participation may then be distributed to the service provider waiting on the users as a gratuity, converted to other virtual items of value (e.g., for use in an external virtual environment), used to pay for the food (or other goods or services, where applicable), gifted to friends, converted to real world currency, and/or used in other ways.

The one or more activities may include one or more of a trivia game, a puzzle game, a shooter game, a strategy game, and/or other games. The virtual items of value may be awarded for achievement within a game, found within the game, and/or acquired within a game in other ways. The one or more activities may include one or more gaming activities in which the users value at risk to gain the opportunity to win one or more virtual items of value. The value placed at risk may include real world currency, and/or one or more virtual items of value. The one or more gaming activities may include wagering of the value on real world events and/or activities (e.g., sporting events, trivia contests, bingo, and/or other real world events). The one or more gaming activities may include wagering of the value on the outcome of activities within the virtual environment (e.g., games of chance, games of skill, and/or other activities within the virtual environment). In the gaming activities, users may wager against a virtual entity within the virtual environment (e.g., a non-player character, and/or other virtual entities), against other users in the virtual environment, and/or with other entities.

The value acquisition module 24 may be configured to award virtual items of value to users for use of system 10. That is, users may be awarded virtual items of value for giving gratuities to service providers in the form of virtual items of value. Such virtual items of value may be distributed responsive to one or more of a user giving a gratuity having at least a threshold value (e.g., real world value, virtual value, and/or other threshold values), a user consistently giving gratuities having at least a threshold value, for participating in value acquisition activities provided by value acquisition module 24, and/or for other activities.

The value acquisition module 24 may be configured to award virtual items of value to users for their patronage generally. For example, responsive to a user showing some level of patronage (e.g., in frequency of purchase, amount of purchase, referral of others, and/or other metrics of patronage), value acquisition module 24 may be configured to award virtual items of value to the user. Virtual items of value may be provided to a user at a purchase of a stored value for redemption at one or more businesses or entities. Responsive to a purchase by a user of a stored value (e.g., in the form of a gift card), some percentage of the purchased stored value may be provided to the user in excess of the purchased stored value and in the form of virtual items of value for distribution as gratuities.

A business may distribute virtual items of value to customers for them to be distributed to service providers in the employ of the business. The business may use distributions of the virtual items of value to incentivize and/or reward employee behaviors. For example, bonuses, give-aways, contests, and/or other opportunities may be provided to employees based on the virtual items of value they have received from users. In such implementations, the virtual items of value may be used and/or exist in a virtual environment that is accessible to customers. Instead, the items of value may be considered “virtual” in that they may not redeemable to the customers, and/or to the employees outside of the context of the present disclosure (e.g., not redeemable with other businesses).

The transaction module 26 may be configured to accept virtual items of value as payment for goods and/or services received from the business. This may include virtual items of value acquired by the users via value acquisition module 24 and/or other virtual items of value.

Processor(s) 12 is configured to provide information processing capabilities in system 10. As such, processor 12 may include one or more of a digital processor, an analog processor, a digital circuit designed to process information, an analog circuit designed to process information, a state machine, and/or other mechanisms for electronically processing information. Although processor 12 is shown in FIG. 1 as a single entity, this is for illustrative purposes only. In some implementations, processor 12 may include a plurality of processing units. These processing units may be physically located within the same device, or processor 12 may represent processing functionality of a plurality of devices operating in coordination. The processor 12 may be configured to execute modules 14, 16, 18, 20, 22, 24, and/or 26. Processor 12 may be configured to execute modules 14, 16, 18, 20, 22, 24, and/or 26 by software; hardware; firmware; some combination of software, hardware, and/or firmware; and/or other mechanisms for configuring processing capabilities on processor 12.

It should be appreciated that although modules 14, 16, 18, 20, 22, 24, and 26 are illustrated in FIG. 1 as being co-located within a single processing unit, in implementations in which processor 12 includes multiple processing units, one or more of modules 14, 16, 18, 20, 22, 24, and/or 26 may be located remotely from the other modules. As a non-limiting example, some or all of the functionality attributed to modules 14, 16, 18, 20, 22, 24, and/or 26 may be provided “in the cloud” by a plurality

of processors connected through a network. The description of the functionality provided by the different modules 14, 16, 18, 20, 22, 24, and/or 26 herein is for illustrative purposes, and is not intended to be limiting, as any of modules 14, 16, 18, 20, 22, 24, and/or 26 may provide more or less functionality than is described. For example, one or more of modules 14, 16, 18, 20, 22, 24, and/or 26 may be eliminated, and some or all of its functionality may be provided by other ones of modules 14, 16, 18, 20, 22, 24, and/or 26. As another example, processor 12 may be configured to execute one or more additional modules that may perform some or all of the functionality attributed below to one of modules 14, 16, 18, 20, 22, 24, and/or 26. In some implementations, processor 12 may be included within a server 50 configured to communicate with one or more client computing platforms 52 in a client/server configuration. It will be appreciated that this is not intended to be limiting, and that the scope of this disclosure includes implementations in which some or all of the functionality attributed herein to server 50 and/or client computing platforms 52 may be provided within a single device, and/or redistributed between server 50 and/or client computing platforms 52 in a different manner.

The server 50 may include electronic storage 54. Electronic storage 54 may comprise electronic storage media that electronically stores information. The electronic storage media of electronic storage 54 may include one or both of system storage that is provided integrally (i.e., substantially non-removable) with server 54 and/or removable storage that is removably connectable to server 54 via, for example, a port (e.g., a USB port, a firewire port, etc.) or a drive (e.g., a disk drive, etc.). Electronic storage 54 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid- state storage media (e.g., flash drive, etc.), and/or other electronically readable storage media. The electronic storage 54 may include one or more virtual storage resources (e.g., cloud storage, a virtual private network, and/or other virtual storage resources). Electronic storage 54 may store software algorithms, information determined by processor 12, information received from server 50, information received from client computing platforms 52, and/or other information that enables server 50 to function as described herein. A given client computing platform 52 may include one or more processors, and electronic display, a control interface, and/or other components. The one or more processors may be configured to execute computer program modules. The computer program modules may be configured to enable or user associated with the given client computing platform 52 to interface with system 10, and/or provide other functionality attributed herein to client computing platforms 52. For example, the computer program modules may include a view module configured to receive view information from server 50 (e.g., generated by value acquisition module 24), and to present a view of the virtual environment (e.g., as described above) based on the received view information. This may facilitate participation by the user of the given client computing platform 52 in the virtual environment. By way of non-limiting example, the given client computing platform 52 may include one or more of a desktop computer, a laptop computer, a handheld computer, a tablet computing platform, a NetBook, a Smartphone, a gaming console, and/or other computing platforms. The given client computing platform may be associated with an individual user or set of users, with an individual service provider, with an individual business, with an individual “station” of a business (e.g., a table in a restaurant and/or other stations).

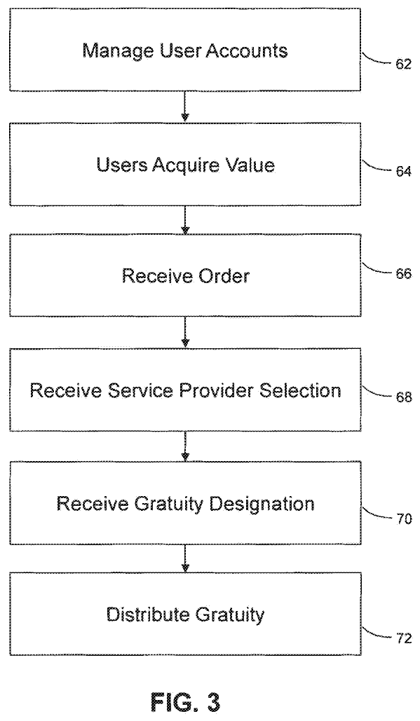

FIG. 3 illustrates a method 60 of facilitating payment of gratuities to service providers with virtual goods and/or virtual currency. The operations of method 60 presented below are intended to be illustrative. In some embodiments, method 60 may be accomplished with one or more additional operations not described, and/or without one or more of the operations discussed. Additionally, the order in which the operations of method 60 are illustrated in FIG. 3 and described below is not intended to be limiting. In some embodiments, method 60 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 60 in response to instructions stored electronically on an electronic storage medium. The one or more processing devices may include one or more devices configured through hardware, firmware, and/or software to be specifically designed for execution of one or more of the operations of method 60.

At an operation 62, user accounts associated with users may be managed. The user accounts may include accounts associated with users purchasing goods and/or services from a business, service providers helping the users on behalf of the business, and/or other users. The user accounts may reflect ownership and/or control of virtual items of value for individual users in one or more virtual environments. In some implementations, operation 62 may be performed by a user account module similar to or the same as user account module 14 (shown in FIG. 1 and described herein).

At an operation 64, users may acquire virtual items of value within one or more virtual environments. This may include providing a virtual environment to the users, and facilitating the users acquisition of virtual items of value within the provided virtual environment. Virtual items of value may be purchased by users, earned by users, won by users, and/or acquired by users in other ways. In some implementations, operation 64 may be performed by a value acquisition module similar to or the same as value acquisition module 24 (shown in FIG. 1 and described herein). At an operation 66, an order placed by one of the users may be received and/or fulfilled. The order may be for one or more goods and/or services from the business. A service provider may help the user on behalf of the business in connection with the purchase. Helping the user may include providing the purchased good and/or service, providing access to the good and/or service, and/or helping the user in other ways in connection with the purchase. In some implementations, operation 66 may include receiving an order by an order module similar to or the same as order module 16 (shown in FIG. 1 and described herein).

At an operation 68, a service provider selection may be received from the user. The service provider selection may include an identification of the service provider that helped the user in connection with the purchase. In some implementations, operation 68 may be performed by a service provider module similar to or the same as service provider module 18 (shown in FIG. 1 and described herein).

At an operation 70, a gratuity designation may be received from the user. The gratuity designation may identify one or more virtual items of value to be included in a gratuity to the service provider identified at operation 68. The one or more virtual items of value may include one or more virtual items of value acquired by the user at operation 64. In some implementations, operation 70 may be performed by a gratuity designation module similar to or the same as gratuity designation module 20 (shown in FIG. 1 and described herein).

At an operation 72, a gratuity including the virtual item(s) of value designated at operation 70 may be distributed to the service provider identified at operation 68. Distributing the virtual item(s) of value may include dividing the virtual item(s) of value between a plurality of individuals included in the service provider.

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

What is claimed is:

1) A method for facilitating payment of gratuities in a virtual environment from a user to a service provider by at least one of virtual goods and virtual currency over an Internet network connection, the method comprising:
managing, by a user account module at a server comprising a database, user accounts associated with users and service provider accounts associated with service providers;
receiving, by a service provider module, at least one service provider selection from a first device associated with a user wherein a service provider selection includes an identification of an identified service provider to which a gratuity will be distributed;
receiving, by a gratuity designation module, an entry or selection by the user of a real world value for the gratuity;
presenting to the user, by the gratuity designation module, one or more of the virtual items of value that are a possibility for the gratuity;
receiving, by the gratuity designation module, a gratuity designation from the user that identifies one or more of the virtual items of value; and
distributing the gratuity over the Internet connection by a gratuity distribution module to the identified service provider from the user.
